(19) United States
(12) Patent Application Publication
(10) Pub. No.: US 2026/0314579 A1
(43) Pub. Date: Oct. 15, 2026

(54) ANTI-STRIPPING FISHHOOK WITH REVERSE TEETH

(71) Applicant: jiangxi Ocean Knight hooks Co.,Ltd, Shangrao (CN)

(72) Inventor: Zhicheng Zhan, Shangrao (CN)

(21) Appl. No.: 19/179,445

(22) Filed: Apr. 15, 2025

(51) Int. Cl. A01K 83/00

(52) U.S. Cl. CPC A01K 83/00

(57) ABSTRACT

An anti-stripping fishhook with reverse teeth is composed of a shank head, a hook shank and a hook tip, the shank head has a flat structure, and the hook shank is provided with reverse teeth, the reverse teeth extend all the way to the hook tip, each reverse tooth is triangular in shape, with a length of a proximal end surface near the shank head being longer than that of a distal end surface farther from the shank head, forming a barb shape, a barb is located on an inner side of a front end of the hook tip. A slope between the distal end surface of the reverse tooth and the hook shank is smaller than that between the proximal end surface and the hook shank. The advantageous effects of the invention are as follows: simple structure, low production cost, and robust durability.

### 1. TECHNICAL FIELD

The invention relates to the technical field of fishhooks, in particular to an anti-stripping fishhook with reverse teeth.

### 2. BACKGROUND ART

A fishhook is a tool used in fishing to suspend bait to attract fish to bite. It typically consists of a shank head, a hook shank, a hook bend, and a hook tip. The development of fishhooks has advanced rapidly, with a wide variety of types available, including those made from stainless steel, alloy steel with carbon materials. Fishhooks also come in various sizes and models. The performance of the fishhook directly affects the success and efficiency of catching fish.

In prior art, fishing line is usually wound around the shank of a hook and restricted from slipping out by a protruding shank head. As the hook shank typically has a smooth cylindrical structure with low friction, the fishing line tends to slide up and down easily when tied onto the hook shank. Additionally, the portion of the fishing line that extends longitudinally toward the shank head experiences lateral sliding friction against the shank head, resulting in an insecure overall structure that is prone to damaging the fishing line.

On the other hand, the hook tip is generally a smooth conical structure, which makes it easy for bait to come off when mounted on it and for the hooked fish to escape after being caught. Moreover, the hook shank is also smooth, further increasing the likelihood of the fish slipping off.

### 3. SUMMARY OF THE INVENTION

In order to address the existing problem of fish easily slipping off the hook after being caught, the invention provides an anti-stripping fishhook with reverse teeth.
In order to realize the above objects, the invention provides the following technical scheme:
the anti-stripping fishhook with reverse teeth is composed of a shank head, a hook shank and a hook tip, the shank head has a flat structure, and the fishhook is provided with reverse teeth along the hook shank, the reverse teeth extend all the way to the hook tip, each reverse tooth is triangular in shape, with a length of a proximal end surface near the shank head being longer than that of a distal end surface farther from the shank head, forming a barb shape, a barb is located on an inner side of a front end of the hook tip.

As a further illustration, a slope between the distal end surface of the reverse tooth and the hook shank is smaller than that between the proximal end surface and the hook shank.

The advantageous effects of the invention are as follows:
1. simple structure, low production cost, and robust durability;
2. increases friction to prevent bait from easily coming off;
3. enhances friction between the fishing line and the hook to prevent the hook from slipping off the line;
4. after a fish is hooked, increases friction between the fish and the hook to prevent the fish from easily escaping.

### 4. BRIEF DESCRIPTION OF ACCOMPANY ING DRAWINGS

FIG. 1 is a schematic diagram of the structure of the fishhook with reverse teeth of the invention;

FIG. 2 is a detailed structural diagram of the reverse teeth of the fishhook with reverse teeth of the invention.

### In the figures

1 hook shank, 2 shank head, 3 hook tip, 4 reverse tooth, 41 proximal end surface, 42 distal end surface.

### 5. SPECIFIC EMBODIMENT OF THE INVENTION

The invention is further described below in combination with the accompanying drawings.

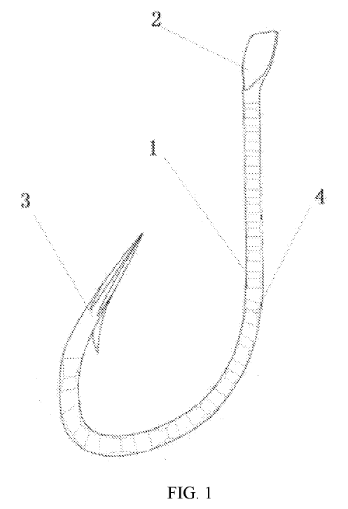

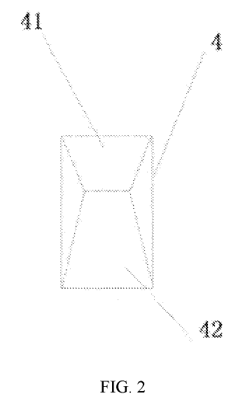

Embodiment: as shown in FIGS. 1 and 2,

an anti-stripping fishhook with reverse teeth is composed of a shank head 2, a hook shank 1 and a hook tip 3, the shank head has a flat structure, and the hook shank 1 is provided with reverse teeth 4, the reverse teeth 4 extend all the way to the hook tip 3, each reverse tooth 4 is triangular in shape, with a length of a proximal end surface 41 near the shank head 2 being longer than that of a distal end surface 42 farther from the shank head 2, forming a barb shape, a barb is located on an inner side of a front end of the hook tip 3.

A slope between the distal end surface 42 of the reverse tooth 4 and the hook shank 1 is smaller than that between the proximal end surface 41 and the hook shank 1; this structure facilitates the fishhook’s penetration into the fish’s mouth. Meanwhile, when the fish struggles, the acute-angle structure formed between the proximal end surface 41 and the plane of the hook shank 1 restricts the fish’s mouth from retracting, making it more difficult for the fish to fall off the hook.

When put into use, the fishhook of the invention adopts a design of reverse teeth, has simple structure, low production cost, and robust durability; it increases friction to prevent bait from easily coming off; it enhances friction between the fishing line and the hook to prevent the hook from slipping off the line; after a fish is hooked, it increases friction between the fish and the hook to prevent the fish from easily escaping.

The basic principles and main features of the invention are described above. Those skilled in the art should understand that the invention is not limited by the above embodiments. The above embodiments and description in the invention are only for explaining the principles of the invention. Without departing from the spirit and scope of the invention, the invention may have various changes and improvements, which shall fall within the scope of the invention to be protected. The protection scope of the invention shall be defined by the attached claims and their equivalents.

1. An anti-stripping fishhook with reverse teeth, composed of a shank head, a hook shank and a hook tip, the shank head has a flat structure, and the fishhook is provided with reverse teeth along the hook shank, the reverse teeth extend all the way to the hook tip, each reverse tooth is triangular in shape, with a length of a proximal end surface near the shank head being longer than that of a distal end surface farther from the shank head, forming a barb shape, a barb is located on an inner side of a front end of the hook tip.

2. The anti-stripping fishhook with reverse teeth of claim 1, wherein a slope between the distal end surface of the reverse tooth and the hook shank is smaller than that between the proximal end surface and the hook shank.
